(19) United States
(12) Patent Application Publication
(10) Pub. No.: US 2015/0242657 A1
(43) Pub. Date: Aug. 27, 2015

(54) SELF-ENCRYPTING DRIVE AND USER DEVICE INCLUDING THE SAME

(71) Applicant: JISOO KIM, YONGIN-SI (KR)

(72) Inventor: JISOO KIM, YONGIN-SI (KR)

(21) Appl. No.: 14/623,533

(22) Filed: Feb. 17, 2015

(30) Foreign Application Priority Data
Feb. 27, 2014 (KR) 10-2014-0023281

(51) Int. Cl. G06F 21/78

(52) U.S. Cl. CPC G06F 21/78

(57) ABSTRACT

A user device is provided which includes a host providing event indication causing a transition between an authentication state and a non-authentication state. The information storage device of the user device has a nonvolatile storage medium and upon entering the non-authentication state the information storage device provides a part of the storage space of the nonvolatile storage medium as an accessible temporary storage space.

### CROSS-REFERENCE TO RELATED APPLICATIONS

A claim for priority is made under 35 U.S.C. §119 to Korean Patent Application No. 10-2014-0023281 filed on Feb. 27, 2014, the subject matter of which is hereby incorporated by reference.

### BACKGROUND

The inventive concept relates generally to data storage devices, and more particularly to self-encrypting drives (SED).

There are many different types of encryption to choose from; host-based, appliance-based and self-encrypting device (SED)-based. All of them have their benefits and drawbacks, but encryption using SEDs is an easy, secure, and affordable method of protecting your critical data.

Host-based encryption is implemented using software. In some cases, there may already be used software that has encryption capabilities. The benefits of software encryption are that it is affordable and may already be included in software that you use. However, there are some major drawbacks to host-based encryption. The most obvious is related to performance. Because host-based encryption uses the host CPU, processor cycles are taken away from other host-based applications. This puts a major drain on system performance. Also, a key for encryption is stored in an area that is not physically protected, and it is exposed on a main memory when used.

Appliance-based encryption is accomplished by inserting an encryption appliance into existing network or infrastructure. Appliance-based encryption overcomes many of the shortcomings of host-based encryption. While host-based encryption uses CPU cycles to secure your data, appliance-based solutions use microprocessor-based hardware systems fully dedicated to encryption. This eliminates any performance degradations. However, there are some drawbacks to appliance-based encryption as compared with SED-based encryption. For example, encryption devices are expensive and needs continuous update.

Encryption using SEDs has revolutionized security by encrypting every piece of data on the drive itself. Unlike other encryption methods, SEDs offer affordable data security with no impact on performance. The SED's hardware encryption engine, which resides in the drive, encrypts all data with no performance degradation. Also, because a key for encryption is physically protected in a drive and is not output outside of a device, security is higher than that of a conventional technique.

### SUMMARY

One aspect of embodiments of the inventive concept is directed to provide a user device comprising; an information storage device including a nonvolatile storage medium providing data storage space, and a host that provides an event indication causing the information storage device to transition from an authentication state to a non-authentication state, wherein the information storage device allows access to only a part of the data storage space provided by the nonvolatile storage medium designated as a temporary storage area in response to an access request received from the host while the information storage device is operating in the non-authentication state.

Another aspect of embodiments of the inventive concept is directed to an operating method for a user device including a host and an information storage device having a nonvolatile storage medium providing data storage space. The method comprising; providing an event indication from the host to the information storage device, in response to the event indication, causing the information storage device to transition from an authentication state to a non-authentication state, while the information storage device is in the non-authentication state, communicating an access request from the host to the information storage device, and in response to the access request, allowing access to only a part of the data storage space provided by the nonvolatile storage medium designated as a temporary storage area.

Another aspect of embodiments of the inventive concept is directed to an operating method for a user device including a host and an information storage device including a nonvolatile storage medium providing data storage space and a memory controller having an encryption unit configured to encrypt/decrypt data. The operating method comprises; assigning a part of the data storage space provided by the nonvolatile storage medium as a temporary storage area while the information storage device operates in a non-authentication state, allowing access by the host to only the temporary storage area while the information storage device operates in a non-authentication state, and allowing access by the host to all of the data storage space while the information storage device operates in an authentication state entered in response to a determination that user-provided authentication information is valid.

### BRIEF DESCRIPTION OF THE DRAWINGS

The above and other objects and features will become apparent from the following description with reference to the following figures, wherein like reference numerals refer to like parts throughout the various figures unless otherwise specified, and wherein

FIG. 1 is a block diagram schematically illustrating a user device according to an embodiment of the inventive concept;

FIG. 2 is a diagram schematically illustrating an encryption level of an information storage device according to an embodiment of the inventive concept;

FIG. 3 is a block diagram schematically illustrating for describing a write operation of a user device performed at an authentication state, according to an embodiment of the inventive concept;

FIG. 4 is a diagram schematically illustrating a data flow at a write operation of a user device performed at an authentication state, according to an embodiment of the inventive concept;

FIG. 5 is a diagram schematically illustrating a data flow at a read operation of a user device performed at an authentication state, according to an embodiment of the inventive concept;

FIG. 6 is a block diagram for describing an operation of a user device when entering an authentication state from a non-authentication state, according to an embodiment of the inventive concept;

FIG. 7 is a diagram schematically illustrating a data flow of a user device when entering an authentication state from a non-authentication state, according to an embodiment of the inventive concept;

FIG. 8 is a block diagram for describing an operation of a user device when entering a non-authentication state from an authentication state, according to an embodiment of the inventive concept;

FIG. 9 is a diagram schematically illustrating a data flow of a user device when entering a non-authentication state from an authentication state, according to an embodiment of the inventive concept;

FIG. 10 is a diagram showing a storage space of a nonvolatile storage medium that is accessible at an authentication state and a non-authentication state;

FIG. 11 is a block diagram for describing an operation of a user device when a user device wants to enter an authentication state from a non-authentication state;

FIG. 12 is a block diagram schematically illustrating nonvolatile storage medium shown in in FIG. 1, according to an embodiment of the inventive concept;

FIG. 13 is a perspective view schematically illustrating a memory block with a three-dimensional structure according to an embodiment of the inventive concept;

FIG. 14 is a circuit diagram schematically illustrating an equivalent circuit of a memory block illustrated in FIG. 13;

FIG. 15 is a block diagram of an example device in which several embodiments may be implemented;

FIG. 16 is a block diagram schematically illustrating a computing system according to an embodiment of the inventive concept;

FIG. 17 is a block diagram schematically illustrating a solid state drive according to an embodiment of the inventive concept;

FIG. 18 is a block diagram schematically illustrating a memory card according to an embodiment of the inventive concept; and

FIG. 19 is a diagram schematically illustrating various systems to which a memory card in FIG. 18 is applied.

### DETAILED DESCRIPTION

Embodiments of the inventive concept will now be described in some additional detail with reference to the accompanying drawings. The inventive concept may, however, be embodied in different forms and should not be construed as being limited to only the illustrated embodiments. Rather, these embodiments are provided as examples so that this disclosure will be thorough and complete, and will fully convey the concept of the inventive concept to those skilled in the art. Accordingly, certain conventionally understood processes, elements, and techniques applicable to the following description of embodiments will be omitted. Unless otherwise noted, like reference numbers and label used in the drawings and written description denote like or similar elements.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

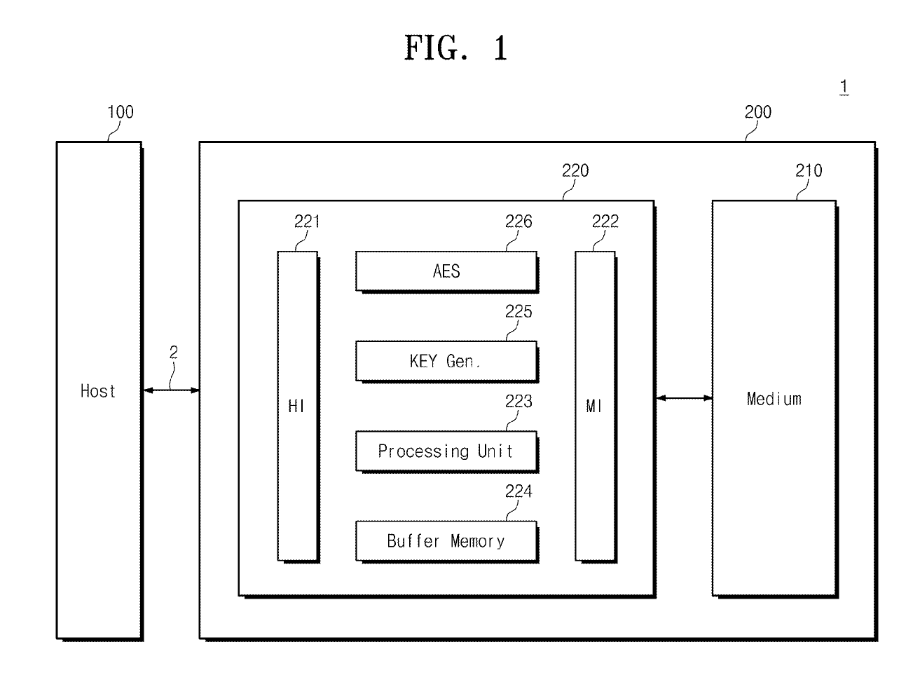

FIG. 1 is a block diagram illustrating a user device according to an embodiment of the inventive concept.

A user device 1 shown in FIG. 1 generally includes a host 100 and an information storage device 200 operatively connected via a communication medium 2. In this configuration, the information storage device 200 serves as a data storage device for the host 100. The communication medium 2 connecting the host 100 and information storage device 200 enables the communications of data (e.g., transmitting and/or receiving) between the host 100 and information storage device 200. The user device 1 may be a personal computer, for example, where the host 100 is a constituent Central Processing Unit (CPU), or a portable electronic device, such as a mobile phone, a personal digital assistant (PDA) and the like.

The host 100 may be configured to provide the information storage device 200 with certain “event indications” such as, for example, an indication that the user device 1 is entering or exiting a sleep mode, a reduced power mode, a particular data communications mode, etc. In this regard, the host 100 may be further configured to transition into and out of various operating modes in response to an authentication procedure.

There are many different types of authentication procedures. Some are user initiated. However, most authentication procedures are executed using one or more forms of authentication information. Here, the term “authentication information” denotes all types of data that may be used during an authentication operation, such as, for example, a pattern authentication, a personal identification number (PIN) authentication, a password authentication, etc. Each of these exemplary authentication operations may be used when an authentication agent is a user or using authentication information that is used when an authentication agent is a remote server (e.g., company's Intranet). During many types of authentication operations, the host 100 will provide the information storage device 200 with authentication information. Only after the provided authentication information has been validated will the host 100 be allowed to access data stored by the information storage device 200.

In FIG. 1, the information storage device 200 includes a nonvolatile storage medium 210. The nonvolatile storage medium 210 may include, for example, a semiconductor memory such as a NAND flash memory. The information storage device 200 may be used to store program information associated with the control of the host 100, user data, and/or many other types of data and information. In the description that follows, it is assumed that the information storage device 200 operates as Self-Encrypting Drive (SED) capable of storing information after the information has been encrypted using a cipher scheme, such as the schemes implemented by use of the Advanced Encryption Standard (AES), for example.

The information storage device 200 of FIG. 1 further includes a memory controller 220 that controls the operation of the nonvolatile storage medium 210, where the memory controller 220 includes a host interface 221, a memory interface 222, a processing unit 223, a buffer memory 224, a key generation unit 225, and an encryption unit 226.

The host interface 221 serves as an interface between the information storage device 200 and host 100. The host interface 221 may be used to output a command or data received from the host 100 to the processing unit 223. The host interface 221 may be used to provide the host 100 with data from the buffer memory 224 and/or certain response notification(s), such as notifications commonly used to indicate execution (or completion) of a command by the processing unit 223.

The memory interface 222 serves as an interface between the memory controller 220 and the nonvolatile storage medium 210. The memory interface 222 may be used to transfer encrypted data from the encryption unit 226 to the nonvolatile storage medium 210, and/or to transfer encrypted data from the buffer memory 224 to the nonvolatile storage medium 210. The memory interface 222 may also be used to receive encrypted data read from the nonvolatile storage medium 210 and transfer the encrypted data to the encryption unit 226, and/or the buffer memory 224.

The buffer memory 224 may be used to temporarily store data being exchanged between the host 100 and information storage device 200 under the control of the processing unit 223. Under the control of the processing unit 223, the buffer memory 224 may be used to store encrypted data output by the host interface 221, data output by the encryption unit 226, and/or data received from the memory interface 222. Under control of the processing unit 223, the buffer memory 224 may also be used to temporarily store data to be transferred to the host 100 via the host interface 221. In addition, the buffer memory 224 may be used to output data to be transferred to the encryption unit 226 under control of the processing unit 223. Thus, as will be understood from the foregoing, the processing unit 223 may be used to control the operation and interoperation of certain function blocks of the information storage device 200.

In certain embodiments of the inventive concept, externally provided data may be transferred to the nonvolatile storage medium 210 via the buffer memory 224, encryption unit 226, and memory interface 222. Or externally provided data may be transferred to the nonvolatile storage medium 210 via the encryption unit 226, buffer memory 224, and memory interface 222. Likewise, data provided from the nonvolatile storage medium 210 may be communicated to the host 100 via the buffer memory 224, encryption unit 226, and host interface 221. Or data provided from the nonvolatile storage medium 210 may be communicated to the host 100 via the encryption unit 226, buffer memory 224, and host interface 221.

The processing unit 223 may be used to effectuate control over the checking of an input command when the host interface 221 receives a command from the host 100. For example, the processing unit 223 may be used to control the interoperation of the buffer memory 224, key generation unit 225, and memory interface 222 during execution of a write operation with respect to the nonvolatile storage medium 210. Similarly, the processing unit 223 may be used to control the interoperation of the buffer memory 224, key generation unit 225, and memory interface 222 during execution of a read oepration with respect to the nonvolatile storage medium 210.

Additionally, the processing unit 223 may be configured to determine whether or not an authentication key provided by the host 100 is a valid authentication key, and the processing unit 223 may thereafter selectively enable a data access request received from the host 100 in response to the validity determination result.

The key generation unit 225 may be variously implemented. For example the key generation unit 225 may be implemented as a random number generator configured to generate a secure key. In this regard, the key generation unit 225 may be implemented using hardware and/or software components or functional blocks. As will be described hereafter in some additional detail, a “secure key” may be used to generate a corresponding “encryption key”.

The encryption unit 226 may be used to encrypt data provided via the host interface 221 and output the corresponding encrypted data to the buffer memory 224, for example. Thereafter, the encrypted data stored in the buffer memory 224 may be transferred to the memory interface 222. Alternately and additionally, the encryption unit 226 may be used to encrypt data provided from the buffer memory 224 and output the corresponding encrypted data to the memory interface 222.

Analogously, the encryption unit 226 may be used to decrypt encrypted data provided from the memory interface 222. That is, the encryption unit 226 may be used to decrypt encrypted data read from the nonvolatile storage medium 210 using an encryption key corresponding to the read requested data. This assumes that the encryption unit 226 has previously been used to encrypt data stored in the nonvolatile storage medium 210 using the encryption key.

If an authentication procedure is not established (or “set”) between the host 100 and information storage device 200, an encryption key may be automatically loaded from the nonvolatile storage medium 210 upon power-up. However, if an authentication procedure is set between the host 100 and the information storage device 200, an encryption key may be loaded from the nonvolatile storage medium 210 when an authentication procedure between the host 100 and the information storage device 200 is passed.

In this regard, the information storage device 200 of FIG. 1 in accordance with certain embodiments of the inventive concept functions as a SED capable of operating in an authentication state and a non-authentication state. Here, the term “authentication state” means a state wherein an access request received from the host 100 is normally processed under conditions where user-defined authentication information provided from the host 100 has been determined to be valid. The term “non-authentication state” means a state wherein an access request received from the host 100 is not normally processed under conditions where user-defined authentication information provided from the host 100 has been determined to be valid.

Hence, data provided from the host 100 in the authentication state may be encrypted using an encryption key that exists only on the information storage device 200. Similarly, data requested by the host 100 in the authentication state may be decrypted using an encryption key that exists only on the information storage device 200. In this manner, access to the information storage device 200 may be selectively enabled through an authentication operation effectuating interoperation between the host 100 and information storage device 200.

In the non-authentication state (e.g., when the user device 10 enters a sleep mode, a screen lock mode, the authentication information provided by the host 100 is deemed invalid, etc.), the information storage device 200 regards all read and write commands received from the host 100 to be invalid. In this regard, the information storage device 200 may send encrypted data to the host 100 without first being decrypted when a read command is received from the host 100 in the non-authentication state.

Alternately or additionally, in the non-authentication state, the information storage device 200 may provide a designated “temporary storage area” for storing data received from the host 100 in the non-authentication state. Where this is done, the host 100 may write data to and/or read data from the temporary storage area without involvement of the encryption unit 226. Or data may be written to and/or read from the temporary storage area using the encryption unit 226, albeit the information storage device 200 using a “temporary encryption key” associated with only data stored in the temporary storage area and performing encryption/decryption operations using the temporary encryption key. In this manner, the information storage device 200 may provide a designated storage area for data used during certain background operations of the host 100 that are routinely executed in the non-authentication state.

Once a background operation has been fully executed, for example, the data stored in the temporary storage area of the nonvolatile storage medium 210 may be erased. In this context, once the information storage device 200 enters the non-authentication state, only the designated temporary storage area may be accessed until such time as information storage device 200 enters the authentication state.

The information storage device 200 of FIG. 1 may be configured to erase certain volatile data (e.g., an encryption key loaded to the encryption unit 226) associated with data encryption operation(s) in response to an indication that the non-authentication state has been entered (e.g., in response to certain information received from the host 100).

With the above description, the information storage device 200 may be configured to block access to the storage medium 210 outside the designated the temporary storage area during the non-authentication state. Yet, the information storage device 200 may enable access to the temporary storage area, as required by the host 100, sufficient to perform certain background operation(s) during the non-authentication state. In this manner, it is possible to better protect data stored in the nonvolatile storage medium 210.

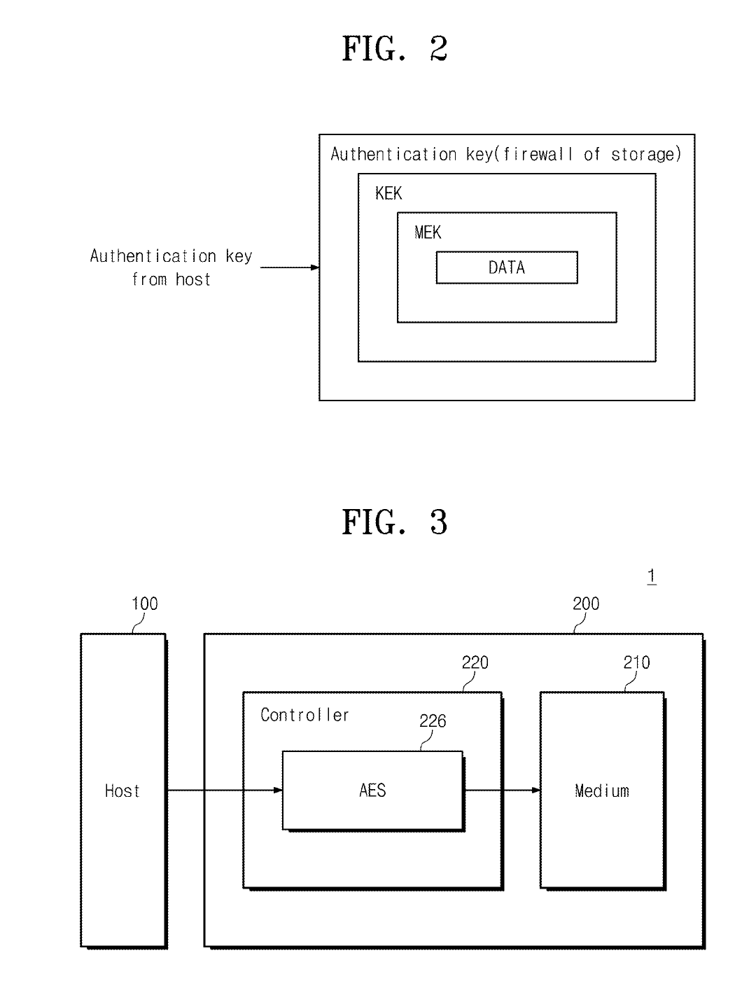

FIG. 2 is a conceptual diagram illustrating different encryption level(s) capable of being provided by an information storage device according to an embodiment of the inventive concept.

In this context, an encryption key may be generated when data storage space of the nonvolatile storage medium 210 is partitioned. For example, when storage space of the nonvolatile storage medium 210 is partitioned into two or more storage areas, the encryption unit 226 and key generation unit 225 may cooperate to generate and assign an encryption key corresponding to each partitioned storage area. The resulting encryption keys may be stored in a specific storage area of the nonvolatile storage medium 210. Here, the encryption key may be encrypted using user-provided information (e.g., authentication information such as password), and the encrypted encryption key may be stored in the specific storage area of the nonvolatile storage medium 210. In this case, it is impossible to read the encryption key without first obtaining the user-provided information.

In FIG. 2, the designation “MEK” denotes a Media Encryption Key needed to encrypt the data; the designation “KEK” denotes a Key Encryption Key needed to encrypt the media encryption key MEK. The key encryption key KEK is encrypted using another key (e.g., hash of a password), and the encrypted media encryption key may be stored in the nonvolatile storage medium 210. Thus, an authentication key (i.e., the secret information required for authentication) may be data obtained from a password, a PIN, the result of biometric recognition, pattern recognition, etc. associated with user authentication.

As illustrated in FIG. 2, data is encrypted using the media encryption key MEK, and the media encryption key MEK is encrypted using the key encryption key KEK for added protection. This encryption may be performed through authentication between the host 100 and information storage device 200. For example, when an authentication key provided from the host 100 is determined to be valid, the information storage device 200 allows an access to the nonvolatile storage medium 210. This result correspond to the “authentication state” described above. In the authentication state, data provided from the host 100 may be encrypted/decrypted using an encryption key that exists only on the information storage device 200.

However, when an authentication key provided from the host 100 is determined to be invalid access by the host 100 to data stored in the information storage device 200 outside a designated temporary storage area is not enabled. And since this data security feature is provided at the drive level (i.e., a functional enablement level) of the information storage device 200, data stored by the information storage device 200 is better protected. In other words, a first authentication operation is performed at the information storage device 200 in connection with the host 100, and the information storage device 200 processes an access of the host 100 as a consequence of determining that the authentication operation is valid. Thus, the corresponding authentication key acts as an operational firewall installed at the information storage device 200 in a SED implemented by embodiments of the inventive concept.

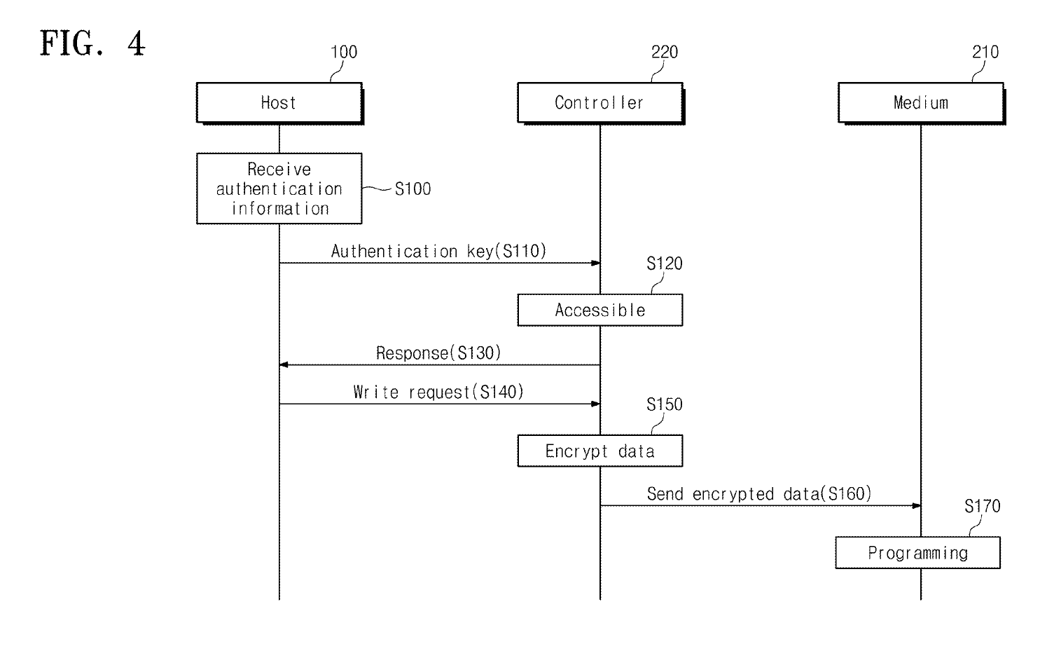

FIG. 3 is a block diagram further illustrating the execution of a write operation by the user device 1 of FIG. 1 according to an embodiment of the inventive concept. FIG. 4 is an operational diagram further illustrating a flow of data during the write operation being executed by the user device 1 of FIG. 3.

Referring to FIG. 3, it is assumed that the information storage device 200 enters an authentication state from an non-authentication state (e.g., that the host 100 transfers an authentication key to the information storage device 200 based authentication information provided by a user). The information storage device 200 enters the authentication state when an authentication key provided from the host 100 is determined to be valid. Afterwards, the host 100 issues a write request, and the information storage device 200 processes the write request.

Referring to FIGS. 3 and 4, the host 100 is capable of receiving user-provided authentication information (S100) during the non-authentication state (e.g., via an input/output device such as touch-screen display). In response, the host 100 determines whether or not the input authentication information is valid. Upon determining that the authentication information is valid (S110), the host 100 sends an authentication key to the information storage device 200. The memory controller 220 of the information storage device 200 then determines whether the authentication key provided by the host 100 is valid. As a consequence of determining that the authentication key that the host 100 provides is valid, the information storage device 200 provides the host 100 with a response indicating accessibility (S130). At this time, the information storage device 200 enters the authentication state. That is, the information storage device 200 enters the authentication state with respect to the host 100. Here, while the operations associated with steps S100, S110, S120 and S130 described above are being performed, a media encryption key MEK used to encrypt incoming write data may not yet reside in the memory controller 220. In contrast to the foregoing, as a consequence of determining that the authentication key that the host 100 is not valid (S110), the information storage device 200 will provide the host 100 with a response indicating inaccessibility. A maximum number of times that the authentication operation may be tried (“re-try's”) in relation to a particular authentication key may be predetermined. Thus, the sequence of steps S100, S110, S120 and S130 described above may be iteratively performed until an authentication key is determined to be valid or the maximum number of re-try's has been reached.

Assuming that the host-provided authentication key has been determined to be valid (S120) and that a response indicating accessibility has been returned to the host 100 (S130), the host 100 may then commence accessing the information storage device 200. For example, the host 100 may issue a “write request” associated with a write operation intended to store “write data” to the information storage device 200 (S140). In response to the write request and upon receipt of the corresponding write data, the memory controller 220 of the information storage device 200 may be used to load a media encryption key MEK corresponding to the write data to be stored in the nonvolatile storage medium 210, and then the encryption unit 226 may be used to encrypt the write data using the loaded media encryption key MEK (S150). In this regard, the media encryption key MEK loaded from the nonvolatile storage medium 210 may be decrypted using a key encryption key KEK prior to the data encryption operation(s). In this manner, the encryption unit 226 may encrypt the write data using the media encryption key MEK that has been decrypted using the key encryption key KEK. Then, the memory controller 220 may be used to send the encrypted data to the nonvolatile storage medium 210 (S160), and the nonvolatile storage medium 210 may program the encrypted data to a storage location corresponding to a received write address (S170).

Thereafter, a response indicating that the write operation identified by the write request has been completed may be communicated to the host 100 from the information storage device 200, either during the programming of the nonvolatile storage medium 210 or after the programming of the nonvolatile storage medium 210, for example.

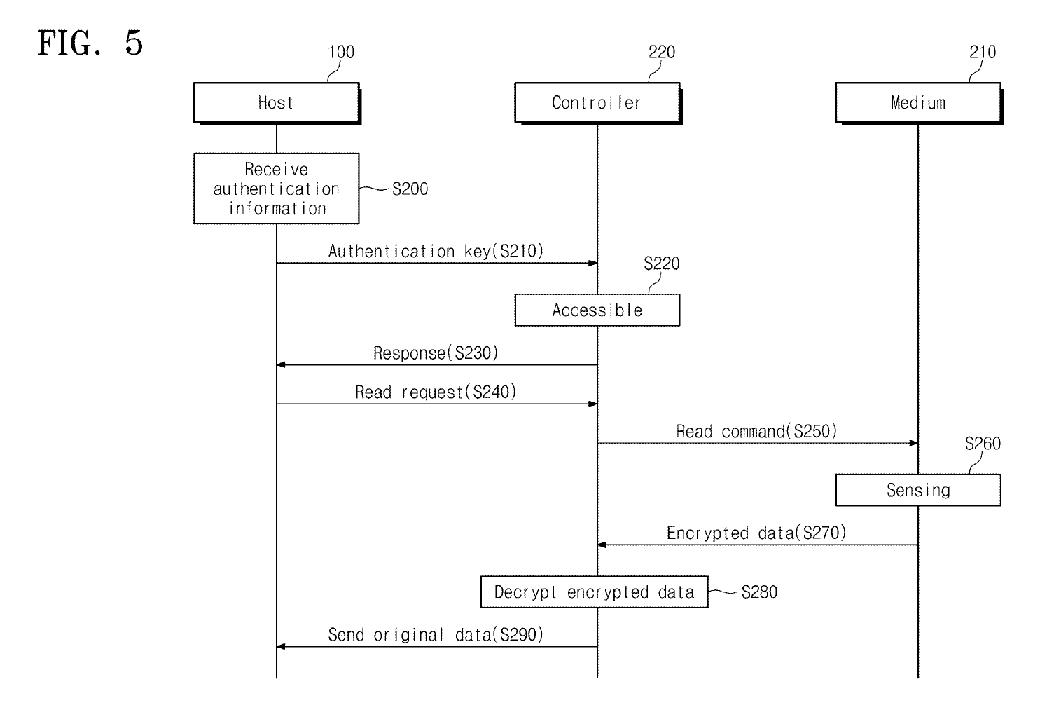

FIG. 5 is an operational diagram illustrating an exemplary flow of data during execution of a read operation being executed by the user device 1 of FIGS. 1 and 3 according to an embodiment of the inventive concept.

For an information storage device 200 to enter an authentication state from an non-authentication state, first, a host 100 transfers an authentication key to the information storage device 200 based on authentication information that a user inputs. The information storage device 200 enters the authentication state when an authentication key provided from the host 100 is determined valid. Afterwards, the host 100 issues a write request, and the information storage device 200 processes the write request of the host 100. This will be more fully described below.

Referring to FIGS. 3 and 5, the host 100 receives user-provided authentication information while in the non-authentication state from (e.g.,) a user input of authentication information via an input/output device (S200). The host 100 then determines whether the input authentication information is valid. As a consequence of determining that the authentication information is valid, the host 100 sends the authentication key to the information storage device 200 (S210). The memory controller 220 of the information storage device 200 then determines whether the authentication key provided by the host 100 is valid, grants (or not) accessibility in response to this determination (S220), and returns an appropriate response (S230).

Assuming a valid determination, the information storage device 200 enters the authentication state and the host 100 may access the information storage device 200. Accordingly, the host 100 issues a read request identifying “read data” currently stored in the nonvolatile storage medium 210 (S240). Then, upon receiving the read request and corresponding read address, the memory controller 220 communicates a read command corresponding to the read request to the nonvolatile storage medium 210 (S250). In response to the read command, the nonvolatile storage medium 210 reads (or senses) the read data identified by the read address as requested by the memory controller 220 (S260). The nonvolatile storage medium 210 then outputs the read data (as previously encrypted) to the memory controller 220 (S270), and the encryption unit 226 of the memory controller 220 decrypts the encrypted read data as received from the nonvolatile storage medium 210 (S280). Thereafter, the memory controller 220 communicates the decrypted (or original) read data to the host 100 (S290).

Here again, a media encryption key MEK needed to decrypt the encrypted read data may be loaded from the nonvolatile storage medium 210 in response to the read request communicated in step S240. Alternately, a media encryption key MEK required to decrypt the encrypted read data may be read via a read operation performed during step S260 and loaded on the encryption unit 226 prior to the output of the read data from memory. It will be understood that the operation of loading the media encryption key MEK to the encryption unit 226 may be variously accomplished.

As described above, the media encryption key MEK loaded from the nonvolatile storage medium 210 may be decrypted using a key encryption key KEK prior to data decryption. The encryption unit 226 may decrypt encrypted data using the media encryption key MEK that is decrypted using the key encryption key KEK.

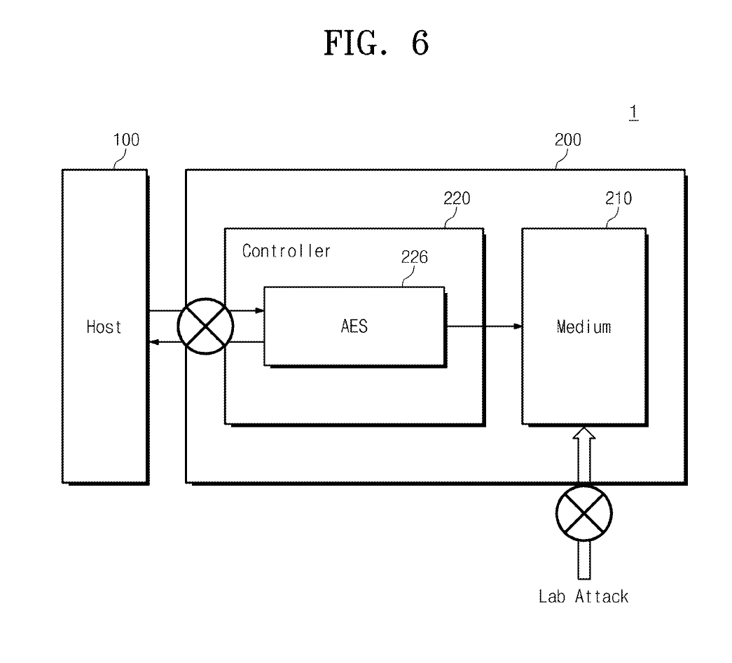

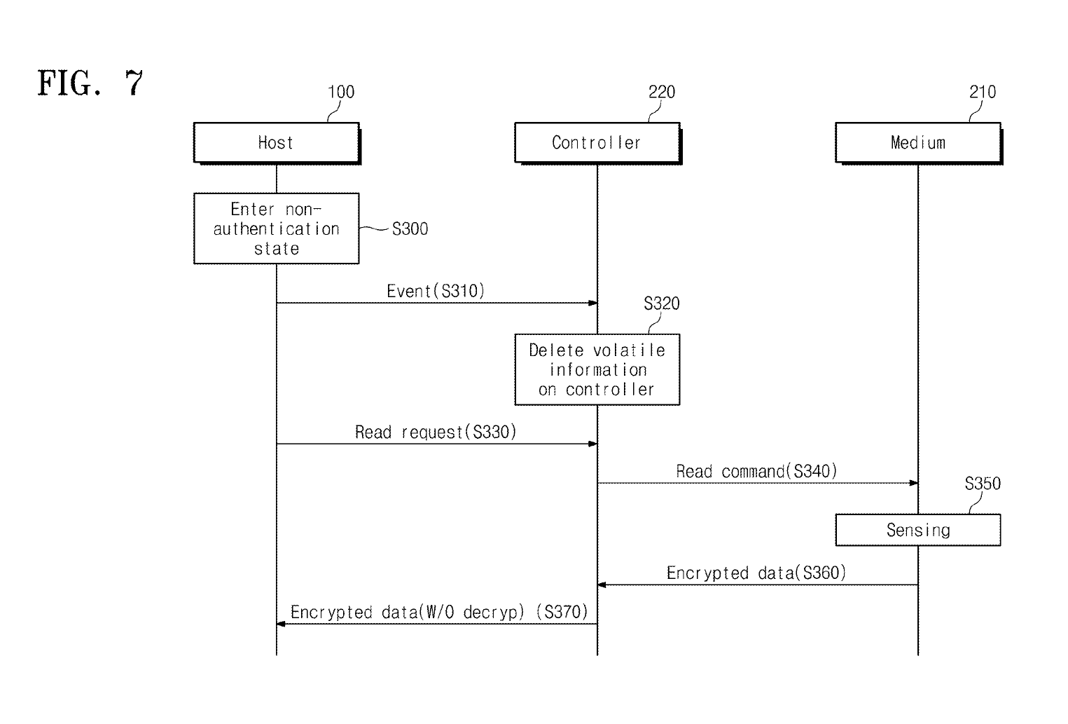

FIG. 6 is a block diagram that will be used to further illustrate in the context of the user device 1 of FIGS. 1 and 3 how operations differ between the authentication state and non-authentication state in certain embodiments of the inventive concept. FIG. 7 is an operational diagram illustrating a flow of data for the user device 1 upon entering the non-authentication state.

Referring to FIGS. 1, 3, 6 and 7, the host 100 and information storage device 200 are initially assumed to be in the non-authentication state, whereupon the user device 1 enters the authentication state (e.g.,) in response to a user input. With this assumption, the information storage device 200 may variously process an operation request issued by the host 100 while in the non-authentication state. For example, when receiving a read request in the non-authentication state, the information storage device 200 may return encrypted data corresponding to the read request to the host 100 without decryption. But in response to a received write request during the non-authentication state, the information storage device 200 may treat the write request is an invalid request.

Thus, when the user device 1 enters the non-authentication state as the result of some event (e.g., entering sleep mode, entering a screen lock mode, upon a power interruption, etc.) (S300), the host 100 may issue a corresponding event indication to the information storage device 200 (S310). In response to the event indication, the information storage device 200 will delete volatile information currently loaded in the memory controller 220 (S320). For example, the memory controller 220 may delete media encryption key information loaded in the encryption unit 226. In certain circumstances wherein information associated with encryption/decryption operation(s) has been loaded in the buffer memory 224, the memory controller 220 may also be used to delete such information.

In this manner, the memory controller 220 may be used to delete all sensitive or potentially exploitable encryption/decryption-related information in response to certain event indications causing the information storage device 200 to enter the non-authentication state. Events causing this response may vary by design but may include circumstances wherein a communication channel between the host 100 and information storage device 200 is blocked or interrupted; an external attack on the user device 1 is detected, the user device 1 is lost or stolen, etc. Thus, as described above, is that it is extremely difficult to decrypt a media encryption key MEK and a key encryption key KEK using an authentication key when the firewall surrounding operation of the information storage device 200 has not first been released. And although encrypted data may be read from the nonvolatile storage medium 210 in response to a read request, the data remains encrypted, thereby making it extremely difficult to ascertain the decrypted version of the data.

Thus, continuing with FIG. 7, it is now assumed that a read request is received from the host 100 while the information storage device 200 remains in the non-authentication state (S330). In response, the memory controller 220 will generate a corresponding read command to the nonvolatile storage medium 210 (S340), and the nonvolatile storage medium 210 will perform a sensing operation in relation to the requested read data (S350), but the nonvolatile storage medium 210 will only output the requested read data in its encrypted form via the memory controller 220 (S360). That is, the memory controller 220 provides the encrypted read data (without decryption) to the host 100. Using this approach, an encryption key is not loaded to the memory controller 220 while the information storage device 200 is in the non-authentication state and only encrypted data may be provided to the host 100.

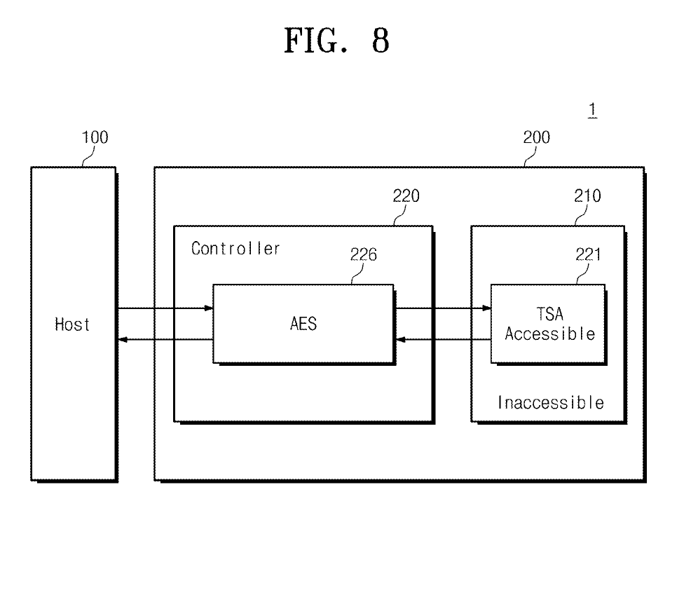

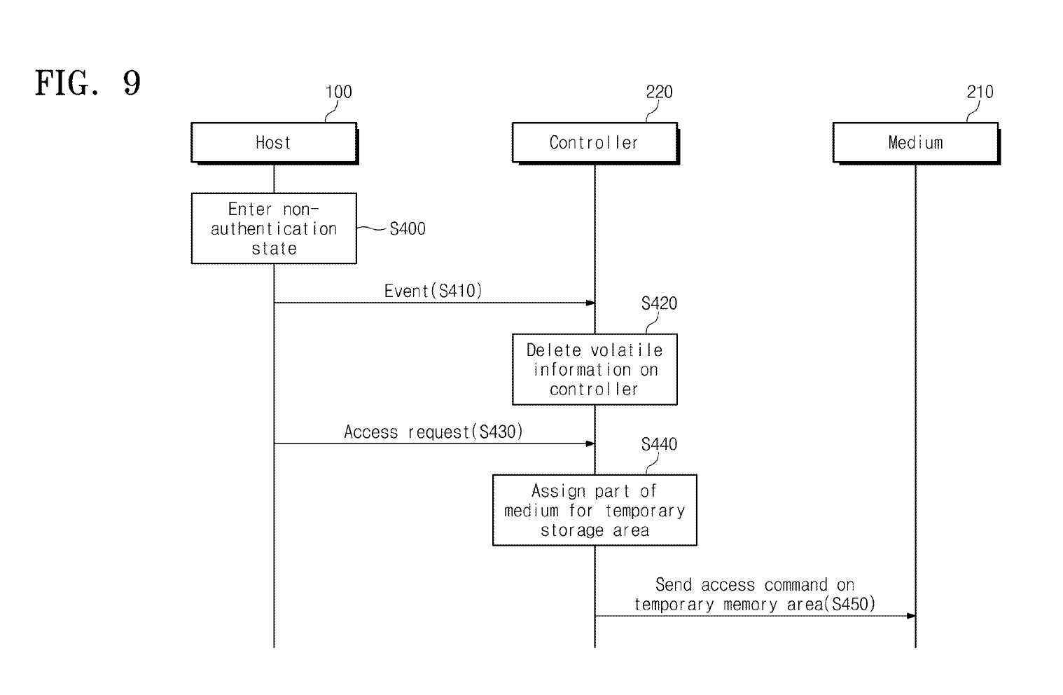

FIG. 8 is another block diagram used to further illustrate in the context of the user device 1 of FIGS. 1 and 3 how operations differ between the authentication state and non-authentication state in certain embodiments of the inventive concept. FIG. 9 is another operational diagram illustrating a flow of data for the user device 1 upon entering the non-authentication state.

Referring to FIGS. 1, 3, 5, 8 and 9, the host 100 and information storage device 200 are again assumed to enter the non-authentication state. Yet, as noted above, the information storage device 200 may process certain requests received from the host 100 while in the non-authentication state. For example, upon receiving an access request in the non-authentication state, the information storage device 200 may nonetheless allow access to only a designated “temporary storage area” of the nonvolatile storage medium 210. That is, a temporary storage area may be used to store message(s) from the host 100 of the user device 1 to the information storage device 200 while operating in the non-authentication state.

For example, after the user device 1 enters the non-authentication state from the authentication state (S400), the host 100 may communicate an event indication (S410). In response to the event indication, the memory controller 220 causes certain “volatile encryption/decryption information” loaded in one or more locations within the memory controller 220 or information storage device 200 to be deleted (S420). The term “volatile encryption/decryption information” is used to denote any stored data that might be exploited by an external agent to defeat the encryption/decryption operations or compromise stored data. Such information is usually stored in a volatile memory location, but may in certain operations be stored in nonvolatile memory. In this context, the memory controller 220 may cause the deletion of media encryption key information loaded in the encryption unit 226 or volatile encryption/decryption information loaded in the buffer memory 224.

Since the user device 1 may store information (e.g., messages) during the non-authentication state, the execution of certain background operations may be facilitated. To support the execution of a background operation by the user device 1, the information storage device 200 according to certain embodiments of the inventive concept may provide a temporary storage area (TSA) 211 when an access request is received from the host 100 while in the non-authentication state. In the context of FIG. 9, the host 100 issues an access request (e.g., a write request) (S430), and in response the information storage device 200 assigns (or designates) part of the nonvolatile storage medium 210 as the temporary storage area 211 (S440). Then, the memory controller 220 may outputs an access command directed to the temporary storage area 211 of the nonvolatile storage medium 210 (S450). For example, assuming a write request, the requested write data may be stored in the temporary storage area 211 of the nonvolatile storage medium 210, and assuming a read request, the requested read data may be read from the temporary storage area 211 of the nonvolatile storage medium 210.

Thus, according to certain embodiments of the inventive concept, access to the temporary storage area 211 may be processed without involvement of the encryption unit 226. Once the user device 1 again enters the authentication state, any data stored in the temporary storage area 211 may be deleted, as necessary.

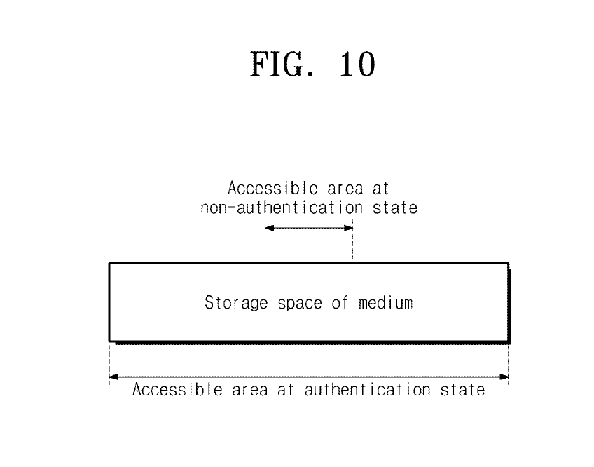

FIG. 10 is a conceptual diagram illustrating one possible layout of the data storage space provided by the nonvolatile storage medium 210 in any one of the previously described embodiments. As can be seen, accessible memory space and its location within a constituent matrix of memory cells forming the nonvolatile storage medium 210 is a function of authentication state or non-authentication state.

Referring to FIG. 10, host-accessible, data storage space of the nonvolatile storage medium 210 while the user device 1 is operating in the authentication state is essentially the entire nonvolatile storage medium 210. However, once the user device 1 enters the non-authentication state, the host-accessible, data storage space of the nonvolatile storage medium 210 drops to the designated temporary storage area 211 that may be used execution of certain background operations.

The temporary storage area 211 may be provided using various manners. For example, the temporary storage area 211 may be a predetermined set of memory blocks, part of a free or empty area of a user area, etc. The size and location of the temporary storage area 211 provided in the non-authentication state may be variable according to a used state of the user area. The temporary storage area 211 provided at the non-authentication state may be formed of continuous or discontinuous storage areas.

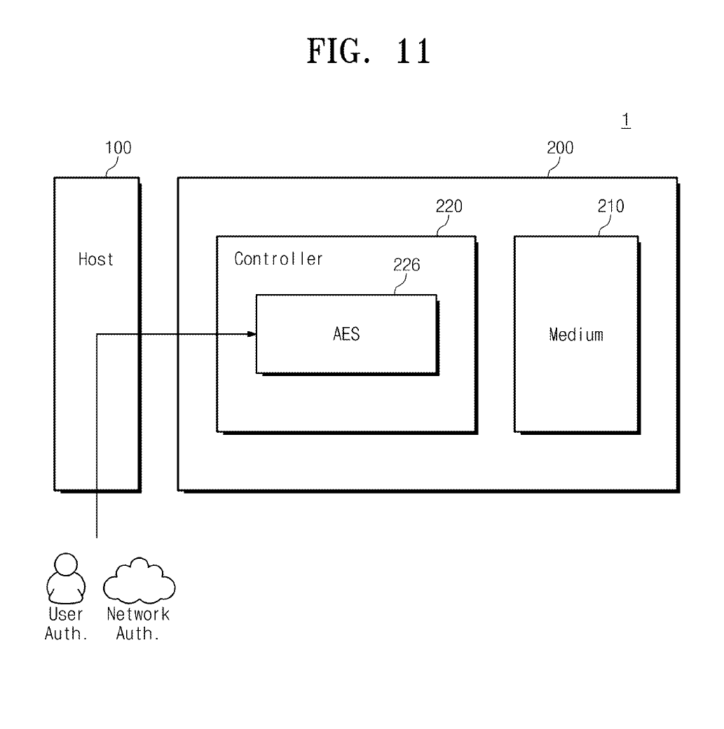

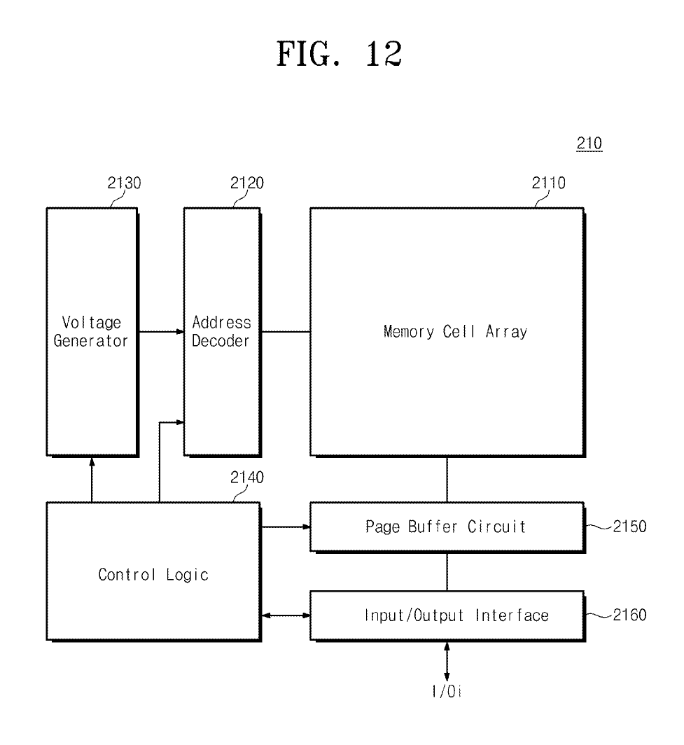

FIG. 11 is another block diagram used to further illustrate in the context of the user device 1 of FIGS. 1 and 3 how operations differ between the authentication state and non-authentication state in certain embodiments of the inventive concept.

In relation to FIG. 11, it is assumed that the host 100 “wake ups” from a sleep mode in response to a user-initiated authentication procedure. When an authentication agent is a user of the user device 1, an authentication operation is performed using authentication information (e.g., pattern authentication, PIN authentication, or password authentication) that the user inputs. If the authentication agent is a remote server (e.g., company's intranet), the authentication operation is performed through the remote server. As a consequence of determining that the authentication information is valid, the host 100 provides the authentication information to an information storage device 200. Afterwards, the host 100 and the information storage device 200 enter the authentication state.

Embodiments of the inventive concept have been described in the context of examples in which an authentication procedure is defined between the host 100 and information storage device 200. However, the inventive concept is not limited thereto. In cases where an authentication procedure is defined between the host 100 and information storage device 200, the inventive concept may support a basic self-encrypting function. Thus, an encryption key for self-encrypting may be automatically loaded on a memory controller 220 from a nonvolatile storage medium 210. Afterwards, the information storage device 200 may perform data encryption/decryption in response to an access request of the host 100.

FIG. 12 is a block diagram further illustrating in one possible example the nonvolatile storage medium 210 of FIGS. 1, 3, 6, 8 and 11.

Nonvolatile storage medium 210 may be a nonvolatile memory device such as a NAND flash memory device. However, it is well understood that the nonvolatile storage medium 210 is not limited to the NAND flash memory device. For example, the nonvolatile storage medium 210 may be formed of, but not limited to, a NOR flash memory device, a Phase-Change Memory (PRAM) device, a Magnetoresistive Random Access Memory (MRAM) device, a Ferroelectric Random Access Memory (FRAM) device, or a Spin Transfer Torque Random Access Memory (STT-RAM) device. Also, the nonvolatile storage medium 210 of the inventive concept may be implemented to have a three-dimensional array structure. A nonvolatile memory device with the three-dimensional array structure may be referred to as a vertical NAND flash memory device. Examples of the vertical NAND flash memory device are disclosed, for example, in U.S. Patent Publication Nos. 2013/0017629 and 2013/0051146, the subject matter of which is hereby incorporated by reference. The inventive concept is applicable to a Charge Trap Flash (CTF) memory device, in which a charge storage layer is made up of an insulation film, as well as a flash memory device, in which a charge storage layer is made up of a conductive floating gate.

Referring to FIG. 12, the nonvolatile storage medium 210 includes a memory cell array 2110, an address decoder 2120, a voltage generator 2130, control logic 2140, a page buffer circuit 2150, and an input and output interface 2160.

The memory cell array 2110 may include memory cells arranged at intersections of rows (e.g., word lines) and columns (e.g., bit lines). Each memory cell may store 1-bit data or M-bit data as multi-bit data (M being an integer of 2 or more). The address decoder 2120 is controlled by the control logic 2140 and performs selecting and driving operations about rows (e.g., word lines, a string selection line(s), a ground selection line(s), a common source line, etc.) of the memory cell array 2110. The voltage generator 2130 is controlled by the control logic 2140 and generates voltages required for each operation such as a high voltage, a program voltage, a read voltage, a verification voltage, an erase voltage, a pass voltage, a bulk voltage, and the like. Voltages generated by the voltage generator 2130 may be provided to the memory cell array 2110 via the address decoder 2120. The control logic 2140 is configured to control an overall operation of the nonvolatile storage medium 210.

The page buffer circuit 2150 is controlled by the control logic 2140 and is configured to read data from the memory cell array 2110 and drive columns (e.g., bit lines) of the memory cell array 2110 according to program data. The page buffer circuit 2150 may include page buffers respectively corresponding to bit lines or bit line pairs. Each of the page buffers may include a plurality of latches. The input and output interface 2160 is controlled by the control logic 2140 and interfaces with an external device (e.g., a memory controller 1200 shown in FIG. 1). Although not illustrated in FIG. 12, the input and output interface 2160 may include, but not limited to, a column decoder configured to select page buffers of the page buffer circuit 2150 by a predetermined unit, an input buffer configured to receive data, an output buffer configured to output data, and so on.

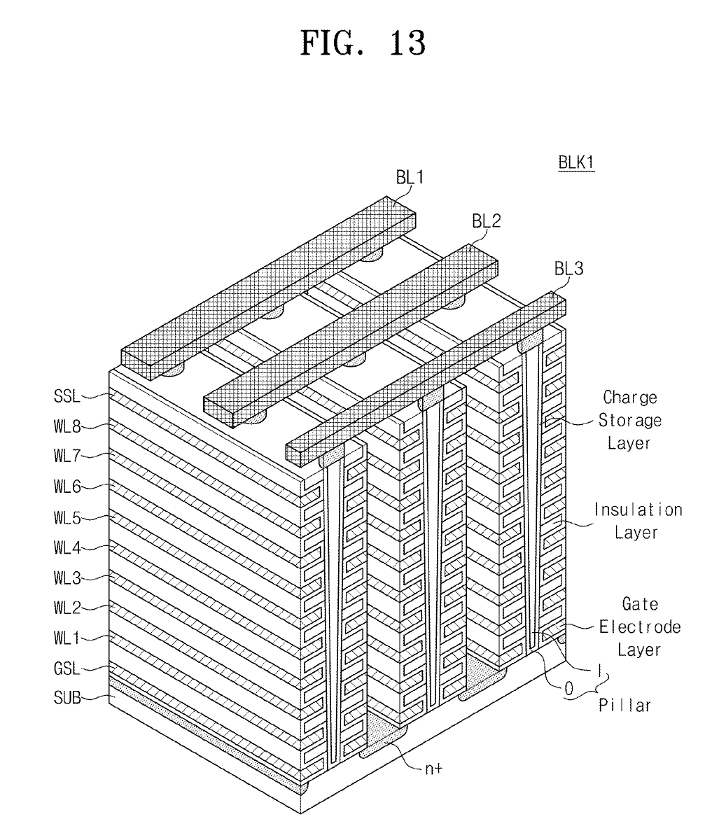

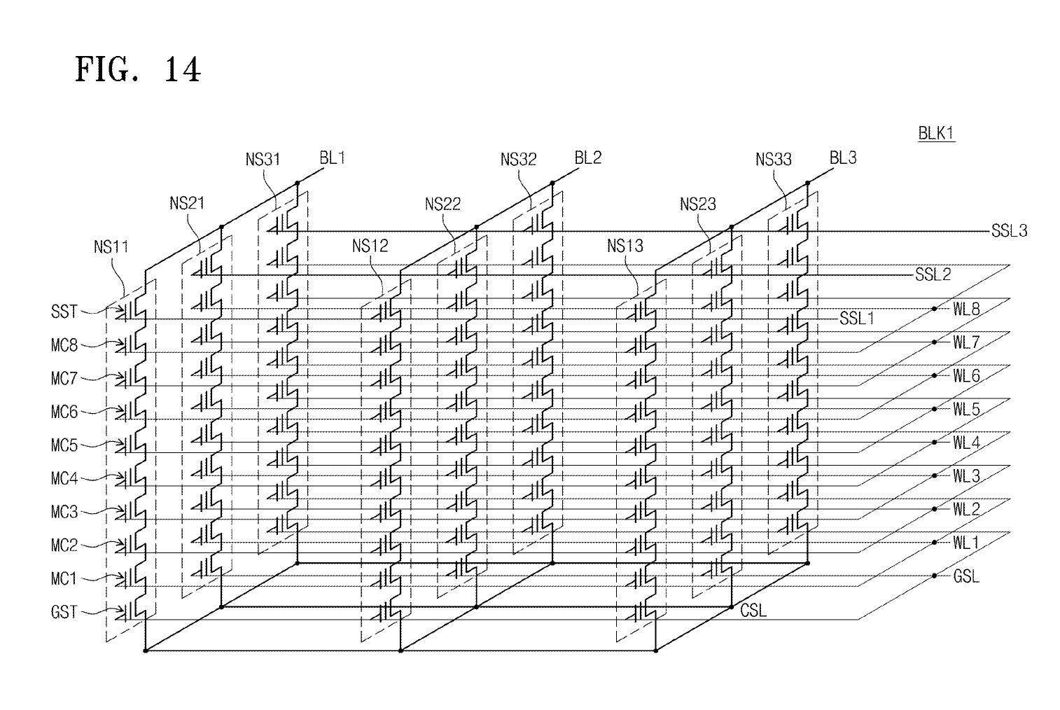

FIG. 13 is a perspective view illustrating a memory block having a three-dimensional structure according to certain embodiments of the inventive concept. Referring to FIG. 13, a memory block BLK1 is formed in a direction perpendicular to a substrate SUB. An n+ doping region is formed in the substrate SUB. A gate electrode layer and an insulation layer are deposited on the substrate SUB in turn. A charge storage layer is formed between the gate electrode layer and the insulation layer.

If the gate electrode layer and the insulation layer are patterned in a vertical direction, a V-shaped pillar may be formed. The pillar may be connected with the substrate SUB via the gate electrode layer and the insulation layer. An outer portion O of the pillar may be formed of channel semiconductor, and an inner portion I thereof may be formed of an insulation material, such as silicon oxide.

The gate electrode layers of the memory block BLK1 are connected to a ground selection line GSL, a plurality of word lines WL1 to WL8, and a string selection line SSL. The pillars of the memory block BLK1 may be connected to a plurality of bit lines BL1 to BL3. In FIG. 13, there is illustrated an example where one memory block BLK1 has two selection lines SSL and GSL, eight word lines WL1 to WL8, and three bit lines BL1 to BL3. However, the inventive concept is not limited thereto.

FIG. 14 is an equivalent circuit diagram for the memory block of FIG. 13. Referring to FIG. 14, NAND strings NS11 to NS33 may be connected between bit lines BL1 to BL3 and a common source line CSL. Each NAND string (e.g., NS11) includes a string selection transistor SST, a plurality of memory cells MCI to MC8, and a ground selection transistor GST.

The string selection transistors SST are connected to string selection lines SSL1 to SSL3. The memory cells MCI to MC8 are connected to corresponding word lines WL1 to WL8, respectively. The ground selection transistors GST are connected to a ground selection line GSL. In each NAND string, the string selection transistor SST may be connected to a bit line, and the ground selection transistor GST may be connected to the common source line CSL.

Word lines (e.g., WL1) with the same height may be connected in common, and the string selection lines SSL1 to SSL3 may be separated from one another. The string selection lines GSL1 to GSL3 may be connected in common. A first word line WL1 and a first string selection line SSL1 are selected to program memory cells connected with a first word line WL1 and included in NAND strings NS11, NS12, and NS13.

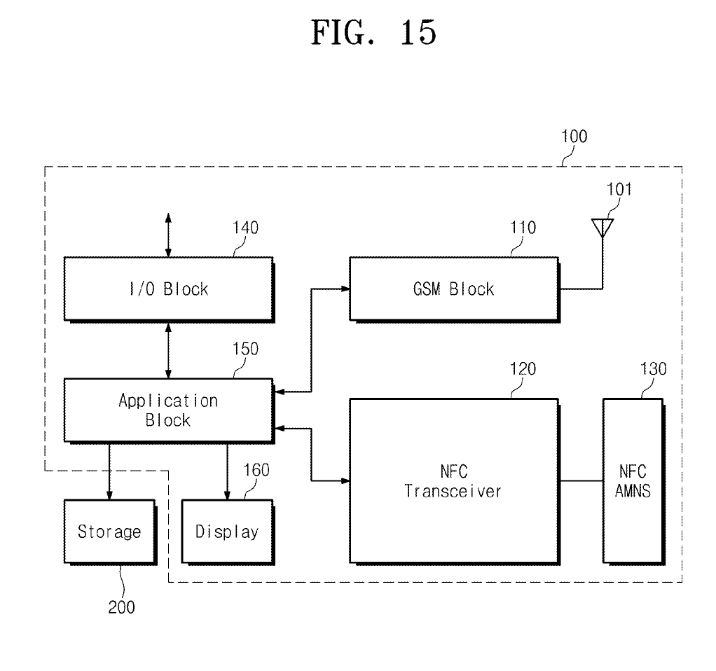

FIG. 15 is a block diagram further illustrating in one example the host 100 of FIGS. 1, 3, 6, 8 and 11. The host 100 illustrated in FIG. 15 may be a mobile phone (or, referred to as a smart phone) as a user device. However, it will be understood that the inventive concept is not limited to only mobile phones.

Referring to FIG. 15, the mobile phone 100 may include a Global System for Mobile Communication (GSM) block 110, a Near Field Communication (NFC) transceiver 120, an NFC antenna matching network system (NFC AMNS) 130, an input/output (I/O) block 140, an application block 150, and a display 160. The components/blocks of the mobile phone 100 in FIG. 15 may be shown merely by way of illustration. However, the mobile phone 100 may contain more or fewer components/blocks. Further, although described as using GSM technology, the mobile phone 100 may instead be implemented using other technologies such as CDMA (Code Division Multiple Access). The blocks of FIG. 1 may be implemented in an integrated circuit (IC) form. Alternatively, some of the blocks may be implemented in an IC form, while other blocks may be in a discrete form.

A host of the mobile phone 100 is connected to an information storage device 200 which is described with reference to FIGS. 1 to 11. The information storage device 200 may be an embedded memory (e.g., eMMC (embedded MMC)) of the mobile phone 100. Or, the information storage device 200 may be an external memory of the mobile phone 100. However, the inventive concept is not limited thereto.

The GSM block 110 is connected to an antenna 101 and operates to provide wireless telephone operations in a known way. The GSM block 110 may contain receiver and transmitter sections internally (not shown) to perform corresponding receive and transmit operations.

The NFC transceiver 120 uses inductive coupling for wireless communication and is configured to receive and transmit NFC signals. The NFC transceiver 120 provides NFC signals to the NFC antenna impedance matching network 130, and the NFC antenna impedance matching network 130 transmits NFC signals through inductive coupling. The NFC antenna matching network 130 receives NFC signals (provided from another NFC device (not shown)) and provides the received NFC signals to the NFC transceiver 120.

The NFC transceiver 120 operates to be consistent with specifications described in Near Field Communication Interface and Protocol-1 (NFCIP-1) and Near Field Communication Interface and Protocol-2 (NFCIP-2) and standardized in ECMA-340, ISO/IEC 18092, ETSI TS 102 190, ISO 21481, ECMA 352, ETSI TS 102 312, etc.

The application block 150 may contain corresponding hardware circuitry (e.g., one or more processors) and operate to provide various user applications provided by mobile phone 100. The user applications may include voice call operations, data transfers, etc. The application block 150 may operate in conjunction with the GSM block 110 to provide such features.

The display 160 may display images in response to the corresponding display signals received from the application block 150. The images may be generated by a camera provided in the mobile phone 100, but not shown in FIG. 15. The display 160 may contain memory (e.g., a frame buffer) internally for temporary storage of pixel values for image refresh purposes and may be implemented, for example, as a liquid crystal display screen with associated control circuits. The I/O block 140 may provide a user with the facility to provide inputs, for example, to dial numbers. In addition, the I/O block 140 may provide outputs that are received via the application block 150.

A user may wake up from the non-authentication state (e.g., a sleep mode) of the mobile phone 1 by inputting authentication information through the display 160 and/or the input/output block 140. The mobile phone 100 will enter the authentication state as a consequence of determining that the received authentication information is valid. The application block 150 may then provide the information storage device 200 with the authentication information input by the user, or authentication information generated therefrom. The information storage device 200 enters the authentication state when the input authentication information is determined as being valid. The information storage device 200 may use an encryption level as described with reference to FIG. 2 (e.g., a self-firewall). Also, the information storage device 200 may provide a temporary storage area for execution of certain background operations while in the non-authentication state.

Thus, the information storage device 200 according to certain embodiments of the inventive concept may block an access to all remaining parts if the storage area other than the temporary storage area while in the non-authentication state. However, the information storage device 200 allows access to the temporary storage area during execution of background operation(s) by the host in the non-authentication state. As a result, it is possible to protect data stored in the information storage device 200 should the mobile phone 100 or information storage device 200 be lost or stolen.

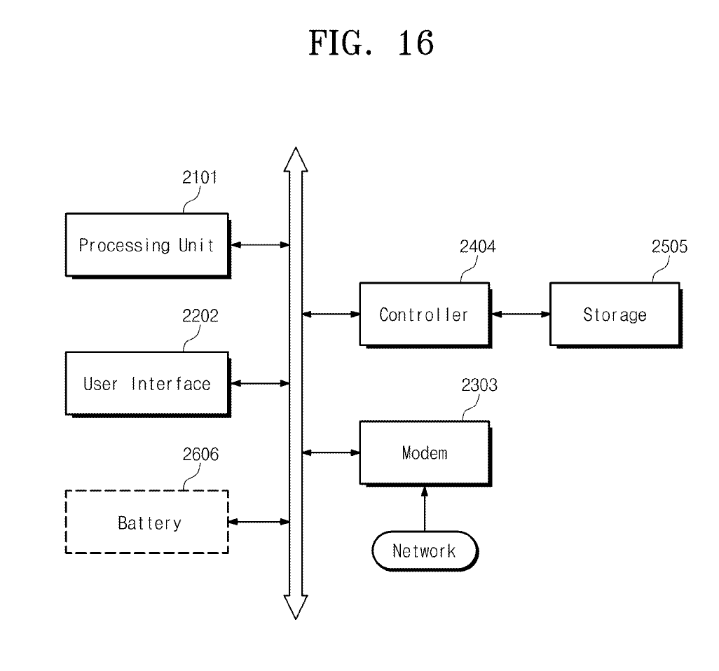

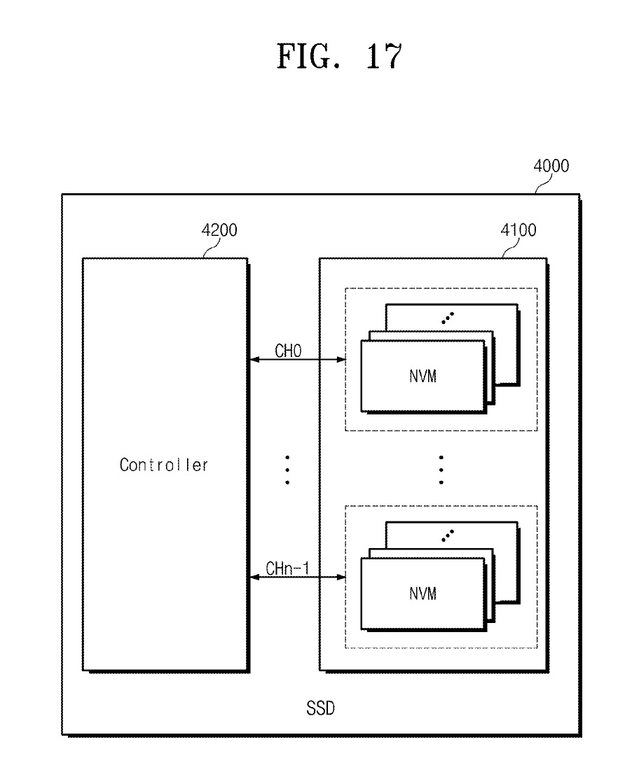

FIG. 16 is a block diagram illustrating a computing system according to an embodiment of the inventive concept. A computing system may include a processing unit 2101, a user interface 2202, a modem 2303 such as a baseband chipset, a memory controller 2404, and storage medium 2505.

The memory controller 2404 is configured the same as that illustrated in FIG. 1, and the storage medium 2505 is formed of a nonvolatile storage medium 210 shown in FIG. 1. N-bit data (N being 1 or more integer) processed/to be processed by the processing unit 2101 may be stored in the storage medium 2505 through the memory controller 2404. In the event that the computing system is a mobile device, a battery 2606 may be further included in the computing system to supply an operating voltage thereto. Although not illustrated in FIG. 16, the computing system may further comprise, but not limited to, an application chipset, a camera image processor (CIS), a mobile DRAM, and the like.

FIG. 17 is a block diagram illustrating a solid state drive (SSD) according to an embodiment of the inventive concept.

Referring to FIG. 17, a SSD 4000 includes storage medium 4100 and a controller 4200. The storage medium 4100 may be connected to the controller 4200 via a plurality of channels, each of which is connected with a plurality of nonvolatile memories in common. The controller 4200 is configured the same as that illustrated in FIG. 1, and each of nonvolatile memory of the storage medium 4100 is formed of a nonvolatile storage medium 210 shown in FIG. 1.

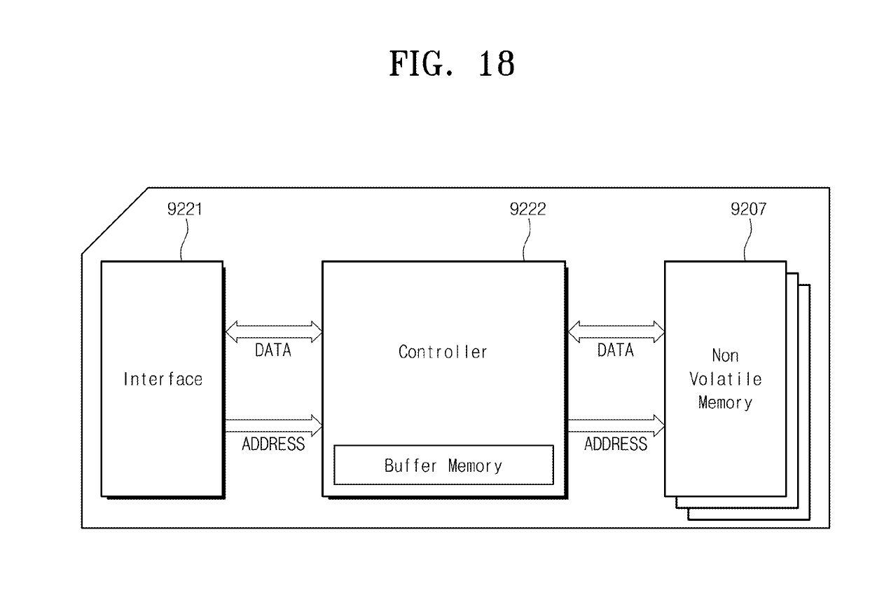

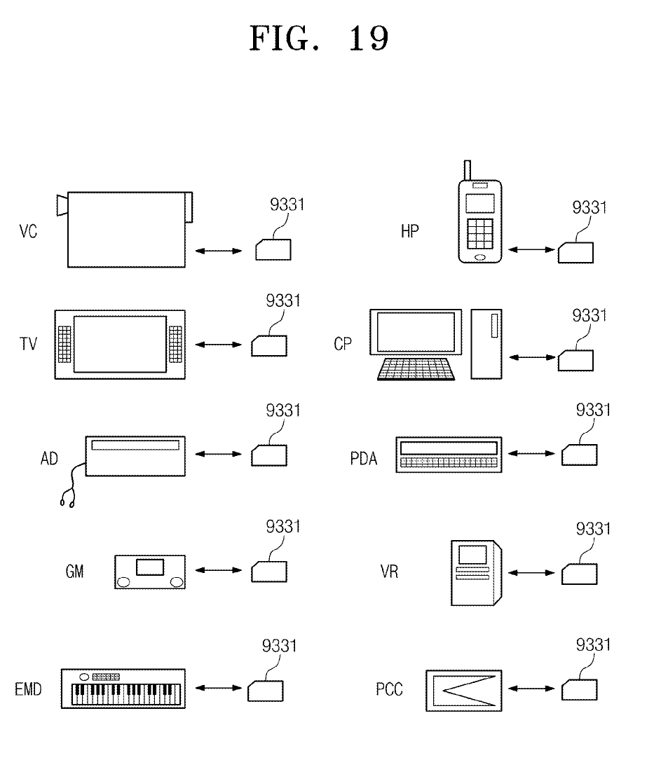

FIG. 18 is a block diagram illustrating a memory card according to an embodiment of the inventive concept.

A memory card, for example, may be an MMC card, an SD card, a multiuse card, a micro-SD card, a memory stick, a compact SD card, an ID card, a PCMCIA card, an SSD card, a chip-card, a smartcard, an USB card, or the like.

Referring to FIG. 18, the memory card may include an interface circuit 9221 for interfacing with an external device, a controller 9222 including a buffer memory and controlling an operation of the memory card, and at least one nonvolatile memory device 9207. The controller 9222 may be a processor which is configured to control write and read operations of the nonvolatile memory device 9207. The controller 9222 may be coupled with the nonvolatile memory device 9207 and the interface circuit 9221 via a data bus and an address bus. The interface circuit 9221 may interface with a host via a card protocol (e.g., SD/MMC) for data exchange between a host and a memory card. Here, the controller 9222 is configured the same as that illustrated in FIG. 1, and the nonvolatile memory device 9207 is formed of a nonvolatile storage medium 210 shown in FIG. 1.

FIG. 19 is a diagram illustrating various systems to which a memory card in FIG. 18 is applied.

Referring to FIG. 19, a memory card 9331 may be applied to a video camera VC, a television TV, an audio device AD, a game machine GM, an electronic music device EMD, a cellular phone HP, a computer CP, a Personal Digital Assistant (PDA), a voice recorder VR, a PC card PCC, and the like.

In certain embodiments, memory cells may be formed of a resistance variable memory cell. Examples of a resistance variable memory cell and a memory device including the same are disclosed in U.S. Pat. No. 7,529,124, the entirety of which is incorporated by reference herein.

In other example embodiments, memory cells can be formed of one of various cell structures having a charge storage layer. Cell structures having a charge storage layer include a charge trap flash structure using a charge trap layer, a stack flash structure in which arrays are stacked at multiple layers, a source-drain free flash structure, a pin-type flash structure, and the like.

In still other example embodiments, a memory device having a charge trap flash structure as a charge storage layer is disclosed, for example, in U.S. Pat. No. 6,858,906 and U.S. Patent Publication Nos. 2004/0169238 and 2006/0180851, the collective subject matter of which is hereby incorporated by reference. A source-drain free flash structure such as that disclosed, for example in KR Patent No. 673020 may be used.

While the inventive concept has been described with reference to certain embodiments, it will be apparent to those skilled in the art that various changes and modifications may be made without departing from the scope of the following claims.

What is claimed is:

1. A user device, comprising:
an information storage device including a nonvolatile storage medium providing data storage space; and
a host that provides an event indication causing the information storage device to transition from an authentication state to a non-authentication state,
wherein the information storage device allows access to a part of the data storage space provided by the nonvolatile storage medium designated as a temporary storage area in response to an access request received from the host while the information storage device is operating in the non-authentication state.

2. The user device of claim 1, wherein the information storage device is a self-encrypting drive device capable of encrypting data received from the host and decrypting data retrieved from the nonvolatile storage medium using a self-encrypting technique.

3. The user device of claim 1, wherein the temporary storage area is variable in size and location within the nonvolatile storage medium in response to a used state of the data storage space provided by the nonvolatile storage medium.

4. The user device of claim 1, wherein the temporary storage area is a fixed storage space in the data storage space provided by the nonvolatile storage medium.

5. The user device of claim 2, wherein the access request is a write access request, and
the information storage device encrypts write data received with the write request while the information storage device is in the non-authentication state and stores the encrypted write data in the temporary storage area.

6. The user device of claim 1, wherein the access request is a read request, and
the information storage device provides encrypted read data identified by the read request to the host without decrypting the encrypted read data.

7. The user device of claim 1, wherein the access request is a read request, and
the information storage device provides read data while in the non-authentication as identified by the read request only from the temporary storage area.

8. The user device of claim 1, wherein the host provides the event indication to the information storage device in response to at least one of the user device entering a sleep mode, the user device entering a screen lock mode, and a power interruption to the user device.

9. The user device of claim 1, wherein the information storage device allows access to all of the data storage space provided by the nonvolatile storage medium upon transitioning from the non-authentication state to the authentication state in response to receiving valid authentication information from the user.

10. An operating method for a user device including a host and an information storage device having a nonvolatile storage medium providing data storage space, the method comprising:
providing an event indication from the host to the information storage device;
in response to the event indication, causing the information storage device to transition from an authentication state to a non-authentication state;
while the information storage device is in the non-authentication state, communicating an access request from the host to the information storage device; and
in response to the access request, allowing access to a part of the data storage space provided by the nonvolatile storage medium designated as a temporary storage area.

11. The method of claim 10, wherein the information storage device is a self-encrypting drive device capable of encrypting data received from the host and decrypting data retrieved from the nonvolatile storage medium using a self-encrypting technique.

12. The method of claim 10, wherein the temporary storage area is variable in size and location within the nonvolatile storage medium in response to a used state of the storage space provided by the nonvolatile storage medium.

13. The method of claim 10, wherein the temporary storage area is a fixed storage space in the storage space provided by the nonvolatile storage medium.

14. The method of claim 11, wherein the access request is a write access request, and the method further comprises:
encrypting write data received with the write request in the information storage device; and
storing the encrypted write data in the temporary storage area.

15. The method of claim 1, wherein the access request is a read request, and the method further comprises:
providing encrypted read data identified by the read request to the host without decrypting the encrypted read data in the information storage device.

16. The method of claim 1, wherein the access request is a read request, and the method further comprises:
providing read data identified by the read request from the temporary storage area.

17. The method of claim 1, wherein the event indication is provided in response to at least one of the user device entering a sleep mode, the user device entering a screen lock mode, and a power interruption to the user device.

18. An operating method for a user device including a host and an information storage device including a nonvolatile storage medium providing data storage space and a memory controller having an encryption unit configured to encrypt/decrypt data, the operating method comprising:
assigning a part of the data storage space provided by the nonvolatile storage medium as a temporary storage area while the information storage device operates in a non-authentication state;
allowing access by the host to the temporary storage area while the information storage device operates in a non-authentication state; and
allowing access by the host to all of the data storage space while the information storage device operates in an authentication state entered in response to a determination that user-provided authentication information is valid.

19. The method of claim 18, further comprising:
entering the non-authentication state in response to an event indication received from the host; and
deleting volatile encryption/decryption information stored in the information storage device upon entering the non-authentication state.

20. The method of claim 18, further comprising:
entering the authentication state upon determining that user-provided authentication information is valid.
